(19) United States
(12) Patent Application Publication
(10) Pub. No.: US 2016/0057173 A1
(43) Pub. Date: Feb. 25, 2016

(54) Media Playback Synchronization Across Multiple Clients

(71) Applicant: Genband US LLC, Frisco, TX (US)

(72) Inventors: Jeffrey Singman, Manalapan, NJ (US); Scott Kidder, Tijeras, NM (US); John Joseph Bloomer, Merritt Island, FL (US)

(21) Appl. No.: 14/800,453

(22) Filed: Jul. 15, 2015

Related U.S. Application Data
(60) Provisional application No. 62/025,437, filed on Jul. 16, 2014.

(51) Int. Cl. H04L 29/06; H04L 29/08

(52) U.S. Cl. CPC H04L 65/1066; H04L 67/02

(57) ABSTRACT

Systems and methods are disclosed for putting a plurality of endpoints in communication with a media host server and a real time communications session manager, wherein a client application running on an endpoint recognizes commands sent to a media host server by a media player running on the endpoint, compares those commands to a pre-programmed set of commands, and sends an indication of the commands to the communications session manager.

### CROSS-REFERENCE TO RELATED APPLICATIONS

The present application claims the benefit of U.S. Provisional Patent Application No. 62/025,437, filed Jul. 16, 2014, and entitled “Optimizing Real-Time Communication Including Guided, Autonomous Remote Browsing,” the disclosure of which is incorporated by reference herein in its entirety.

### TECHNICAL FIELD

The present description relates, in general, to communication systems and, more specifically, to systems and techniques for synchronizing playback of streaming media across multiple user endpoints.

### BACKGROUND

Internet-based real time communication sessions are becoming increasingly popular ways to collaborate, and are used for collaborations ranging from business meetings to customer service and technical support. Real time communication technologies allow users on various devices to share with other users in the session what they are viewing on their screen as well as to communicate by text, voice and video. When sharing streaming media, however, a high bandwidth cost may be incurred by the server hosting the session as it re-streams the media from one user devices to all other user devices connected to the communication session. It is therefore desirable to avoid re-streaming high-bandwidth media to other users in a real time communication session. At the same time, however, it is important to make sure that the users connected to the session are able to synchronize streamed media playback, including pausing and jumping to different time stamps within a media file.

### SUMMARY

In one example, a computing device, the computing device being associated with a first user in a real time communication session over a network, comprises a memory containing machine readable medium comprising machine executable code having stored thereon instructions for performing a method of providing electronic media playback; a processor coupled to the memory, the processor configured to execute the machine executable code to: send and receive voice data with a second user at another computing device as part of the real time communication session; during the real time communication session, detect media playback control signals sent by a media streaming application at the computing device; and in response to detecting the media playback control signals, sending an indication of the media playback control signals to a session management server associated with the real time communication session.

In another example, a method performed by a session management server in a network, the session management server facilitating a real-time communication session between a first endpoint device and a second endpoint device, comprises monitoring the first endpoint device in the network for control signals sent from a media player on the first endpoint device to a media host corresponding to the media player; recognizing at least one playback command by comparing the control signals to a predefined set of control signals; and sending a message to the second endpoint device informing the second endpoint device of the at least one playback command.

In another example, a computer program product having a computer readable medium tangibly recording computer program logic for synchronizing media playback at a first network device, comprises code to engage in a real time communication session by sending and receiving at least voice data with a second network device; code to monitor a media streaming player at the first network device for control signals communicated between the media streaming player and a media host server; and code to send a message indicative of the control signals to a network session manager that is separate from the media host server.

### BRIEF DESCRIPTION OF THE DRAWINGS

FIG. 1 is a diagram of an embodiment of a system connecting endpoints to each other through a session manager and to a streaming media host.

FIG. 2 is a flowchart illustrating a method for beginning synchronized streaming of media across all endpoints.

FIG. 3 is a flowchart illustrating a method for mirroring playback commands from one endpoint to all other endpoints in a real time communication session while all of the endpoints are independently streaming a video from media host.

FIG. 4 is an illustration of an example computer system adapted according to an embodiment of the present disclosure.

FIG. 5 is an illustration of an example signal flow diagram according to one embodiment.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Embodiments of the present disclosure describe systems and methods for synchronizing streaming media playback between user endpoints, also known as endpoint devices, in a real time communication session. In various embodiments this is accomplished by relaying commands that are input to a media player at one endpoint to the other endpoints participating in the real time communication session. The other endpoints then execute the same command on their respective media players. The illustrations below discuss several embodiments, such as HTTP, Web RTC, session initiation protocol (SIP), and others. However, it is understood that the principles discussed herein may be adapted to any appropriate protocol or standard.

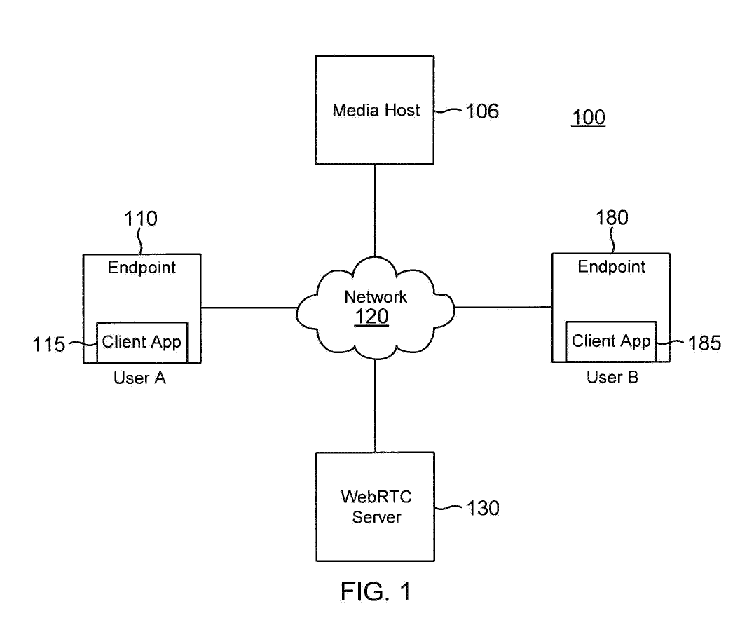

FIG. 1 illustrates an example network architecture 100 in which embodiments may be incorporated. The network architecture 100 includes network device 110, which is associated with user A in this example. Network device 110 may include any appropriate type of device, such as a laptop computer, desktop computer, smartphone, tablet, or the like. Network device 110 may alternately be referred to as a user device or an endpoint. In this example, user device 110 runs a client application 155 that has Web RTC functionality and media playing functionality.

Device 110 communicates over network 120 with WebRTC server 130 (a type of session manager) and media host 106. Although network 120 is shown as the Internet, it is understood that various embodiments may communicate across any appropriate network. For example, device 110 may communicate via a Local Area Network (LAN), Wide Area Network (WAN), cellular network, or other network to reach servers 130 and 106 as well as endpoint 180.

The various servers 106 and 130 of FIG. 1 are shown as single boxes for ease of illustration herein. However, the concept of a server in FIG. 1 may include more than one server, so for instance, media host 106 may represent a single server computer or multiple server computers working together to stream media content The same is true Web RTC server 130—a single box can represent one or more servers. Various embodiments may include any appropriate hardware to act as a server, such as a general purpose computer running an operating system such as Linux.

WebRTC server 130 is in communication with the endpoints 110 and 180. WebRTC server 130 can provide communication between endpoint 110 and the endpoint 180 of user B over the same network or a different network. In the example of FIG. 1, WebRTC server 130 includes APIs that can communicate with both client 115 and client 185, thereby allowing voice, data, and messages to traverse one or more networks. Server 130 can be used to provide services to multiple users at multiple endpoints which can be all in the same network or in different networks, although the present illustration shows only two users (user A and user B). WebRTC server 130 in other embodiments may connect various endpoints over other networks, such as a cellular or landline telephone network.

Endpoint device 180 is a device used by user B to communicate over the communication network 170. Examples of devices that can be used by user B include a phone, laptop computer, a smartphone, a desktop computer, a tablet, and the like. Endpoint device 180 may alternatively be referred to as a user device or a network device. Endpoint device 180 also runs a client application 185, which provides Web RTC functionality as well as media streaming functionality.

In an example use case, user A desires to make a call to user B. User A has application 115 open on her computer, and application 115 provides a web browser that is WebRTC enabled so that the WebRTC functionality provides an interface for initiating the call. For instance, user A may have a message with an HTTP link, where clicking on the link causes application 115 to attempt to establish the call. Functionality 115 communicates over network 120 with WebRTC server 130 to set up the call. For instance, web RTC server 130 may use one or more signaling protocols, such as SIP or other protocol, to set up and establish a call between clients 115 and 185. Also, once communication is set up, voice and video may be sent using, e.g., Real-time Transport Protocol (RTP) or other protocol between clients 115 and 185 over network 120. File sharing may be performed using, e.g., File Transport Protocol (FTP) or other protocol.

In one example use case, user A is a consumer visiting a website of a merchant. User B is a customer service representative acting on behalf of the merchant. As user A browses the e-commerce website, the user sees an active element on the screen that offers a live chat with a customer service representative. The active element on the screen includes a link to a URL. User A, via client 115, selects the link, which initiates the establishment of a real-time communication session with user B at endpoint 180 and client application 185. User B may then answer questions and provide sales information to user A through use of the real-time communication session that is facilitated by Web RTC server 130.

In some cases it may be desirable for the members of the real time communication session to watch or listen to a piece of streaming media simultaneously and in synchronization. For example, the customer service representative (user B) may wish to show the customer a troubleshooting instructional video. In such cases, each endpoint 110 and 180 may connect independently to the media host 106 to stream the same media such as video, audio, etc. at the same time. For simplicity, streaming video will be referred to for the embodiments herein, and it is understood that streaming may include any type of media, such as audio and video.

Continuing with the example, user B at application 185 may select a URL (or other address) that points to a particular piece of streaming media. In response to the selection of the streaming media, client application 185 sends an indication of the link (e.g., a message including the link itself) to application 115 over network 120. Alternatively, Web RTC server 130 may receive an indication of the link from application 185 and provide that link to application 115. Client application 115 selects the link in response to receiving the message. As each application 115, 185 selects the link, they both open independent media streaming sessions with media host 106 and view independent streams of the same piece of streaming media content.

As noted above, each application 115, 185 includes a media player that is operable to receive streaming media content and to render that media content at its respective endpoint device 110, 180. Also, as explained further below, each client 115, 185 has an interface for receiving user commands from the user. Examples include touchscreens with selectable play, pause, and stop buttons, though the scope of embodiments is not limited to any particular interface elements.

Various embodiments provide for synchronized playing of the streaming media sessions at endpoints 110, 180. For instance, the media players of applications 115 and 185 use application programming interfaces (APIs) to communicate with media host 106 and to control the media playback. Applications 115 and 185 also communicate either the signals of the APIs themselves or indications of streaming control actions to Web RTC server 130. Web RTC server 130 then communicates that information to the other respective application 115 or 185.

Continuing with the example, applications 115 and 185 as well as Web server RTC may include techniques to start the media streams at substantially the same time so that they start in a synchronized state. For instance, Web RTC server 130 may send commands to each of the endpoints 115 to cause them to start playing at the same time. However, the scope of embodiments is not limited to any technique to cause the streaming media sessions to begin at the same time.

At this point, user A and user B are communicating at least using voice via a real-time communication session that was set up by Web RTC server 130. Clients 115 and 185 also have begun media streaming sessions for a same piece of media content that is provided by media host 106. Examples of streaming media content may include e.g., MP4 multimedia files or other appropriate media content.

Continuing with the example, user A may desire to pause the video and ask a question of user B. Accordingly, user A selects a pause button from the video player interface. The selection of the pause button causes the media streaming player at client 115 to send control signals according to established APIs to media host server 106 to cause media host server 106 to pause the stream. Client application 115 recognizes the signals according to the API and sends a data message to Web RTC server 130 over network 120 informing Web RTC server 130 that the media content stream has been paused by user A. The message from client application 115 to Web RTC server 130 may include a message having the API signals and/or another appropriate indication of the playback command. Web RTC server 130 then passes a message to client 185 informing client 185 of the playback command. Similarly, the message from Web RTC server 130 to client 185 may include the API signals themselves and/or another appropriate indication of the playback command. Upon receipt of the message from Web RTC server 130, client application 185 also pauses the media content stream by communicating signals according to the API to media host 106 to cause media host 106 to pause the stream.

The example above is provided with respect to synchronizing a pause playback command. Clients 115, 185 and Web RTC server 130 perform a similar technique to restart the playback later. What this example is given with respect to pause and restart, the scope of embodiments may apply this technique to any playback command, including rewinding, fast forwarding, speeding up or slowing down, and scrubbing.

Also, the embodiment described above includes the applications 115, 185 including media streaming player functionality. However the scope of embodiments may also include Web RTC applications being separate from media streaming players. In such embodiments, applications 115 and 185 may include functionality to observe the streaming sessions between the media players and host server 106 to recognize control signaling to capture playback commands and also apply that control signaling to the players to implement playback commands.

Various embodiments may include advantages over prior solutions. The ability to relay streaming media playback commands from one endpoint 110 to another endpoint 180 through a Web RTC server may significantly reduce the bandwidth used by the system. By contrast, in a conventional screen-sharing system, for example, the endpoint whose screen is being shared must use network bandwidth to re-stream media to the other endpoint. In another embodiment with multiple endpoints the bandwidth required to re-stream media is multiplied by the number of endpoints. However, various embodiments described herein share control information, rather than the media, thereby reducing bandwidth use between the endpoints 110, 180 and the server 130. Additionally, the ability to relay streaming media playback commands from endpoint 110 to endpoint 180 and vice versa allows bidirectional synchronization of media playback, in contrast to conventional screen-sharing systems, where only the endpoint whose screen is shared has control of media playback.

Furthermore, present embodiments solve a problem unique to network communications and network streaming. For example, the need to minimize bandwidth use of streaming media did not exist prior to the use of communication networks to stream media in real time. In another example, the need to allow bidirectional control of synchronized streaming media being viewed simultaneously by multiple parties did not exist prior to the use of communication networks to facilitate multi-party synchronized viewing of streaming media.

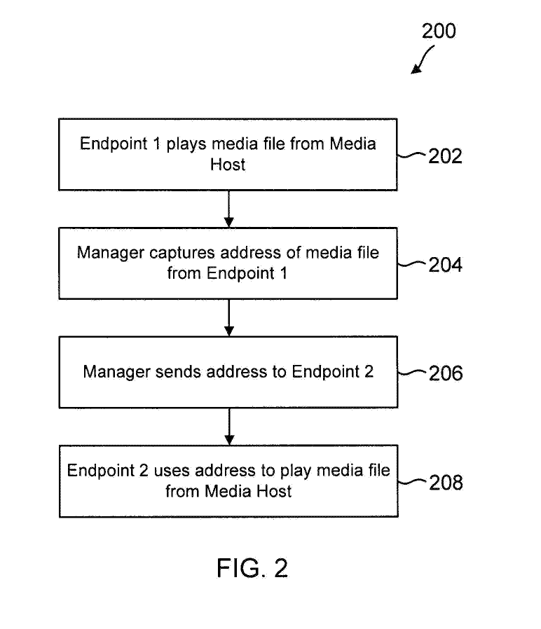

FIG. 2 is a flowchart illustrating a method 200 for beginning synchronized streaming of media between endpoints 110, 180. It should be noted that the example of FIG. 1 shows only endpoints 110, 180, but the scope of embodiments is not limited to any particular number of endpoints. Rather, the techniques described herein may be scaled to provide synchronized streaming among any appropriate number of two or more endpoints.

Beginning at block 202, user A of endpoint 110 uses client 115 to choose a streaming video tile to play from media host 106. The video player within client application 115 at endpoint 110 begins streaming the video file from the media host 106. As noted above, the video selection is implemented via an API. Therefore, when the user selects a video file from the user interface, the media player translates that selection into a predefined set of control signals and causes the endpoint to send those control signals in a message (e.g., via HTTP over the Internet 120) to the media host server 106. The media host server 106 receives those signals and accordingly begins a stream including the requested media.

Moving to block 204, the client application 115, which monitors the commands given to the media player, detects the media playback control signal representing the playback command, compares the control signal to a pre-programmed set of control signals representing playback commands, recognizes the command to play the selected media file and sends a data message to Web RTC server 130 over network 120 informing Web RTC server 130 that the media file has been selected. As noted above, the pre-programmed set of control signals representing playback commands corresponds to an API, and in some embodiments the client application 115 (and 185) may have a data structure such as a database that includes a plurality of entries corresponding to preprogrammed control signals and commands. The client 115 (and 185) may compare detected control signals to the preprogrammed control signals in the data structure to determine playback commands. The message from client application 115 to Web RTC server 130 may include a message having the API signals, an address of the selected media file, and/or other appropriate indication of the media playback selection.

Moving to block 206, the Web RTC server 130 then passes a message to client application 185 at endpoint 180 over network 120 informing client application 185 of the media playback selection. Similarly, the message from Web RTC server 130 to client 185 may include the API signals and/or another appropriate indication of the media playback selection and may include an address or other identification of the particular media streaming file. In some embodiments, the WebSocket protocol is used to send the message from Web RTC server 130 to endpoint 180 and vice versa. In other embodiments, any suitable transport protocol may be used to send the message from Web RTC server 130 to endpoint 180 and vice versa. In some embodiments, separate pieces of software or hardware on Web RTC server 130 may handle recognizing the command from client application 115 to media host 106 and sending the message to client application 185.

Moving to block 208, the client application 185 at endpoint 180 accesses the streaming video file from the media host 106 by using the information contained in the message from Web RTC server 130 to communicate signals according to the API to media host 106, causing the media host 106 to begin streaming the selected media file to the client application 185. In this way, the endpoints 110, 180 independently stream the same video file from the media host 106 at the same time. In some embodiments, client application 185 may also open a media streaming player at the endpoint 180 in response to the message from web RTC server 130.

In some embodiments, the Web RTC server 130 may correct for latency between the media host 106 and the endpoints 110, 180 and between the Web RTC server 130 and the endpoints 110, 180 in order to delay beginning playback of the streaming video file for better synchronization. The information necessary to delay beginning playback may be included in the message sent during block 206. In other embodiments, a separate message may be sent containing the information necessary to delay playback. In other embodiments, latency may be low enough that playback is acceptably close to perfect synchronization without correction for latency.

In some embodiments, it is desirable to maintain synchronization of the streaming video being viewed at each endpoint by mirroring any playback commands input by one endpoint 110 to endpoints 180. Playback commands include pause, play, rewind, fast forward, mute, scrubbing, etc. In other words, when any one of the endpoints 110, 180 pauses, plays, rewinds, fast forwards, mutes, scrubs, etc. the other endpoint 180, 110 will automatically perform the same action to maintain synchronization. For example, if endpoint 110 is used by a customer service representative and endpoint 180 is used by a customer, the customer service representative is playing a product tutorial video for the customer, and the customer service representative wants to pause the video to explain something to the customer, the customer's video playback will pause when the customer service representative pauses his video playback.

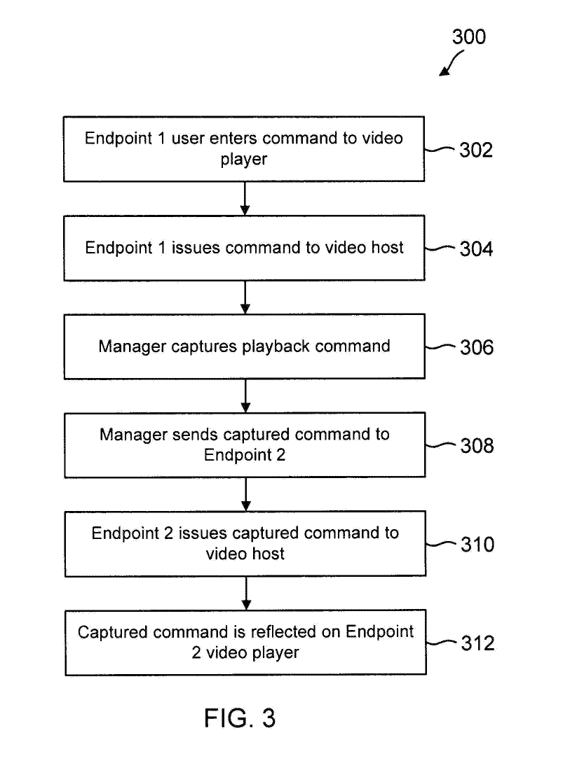

FIG. 3 is a flowchart illustrating a method 300 for mirroring playback commands from one endpoint 110 to the other endpoint 180 (and vice versa) in a real time communication session while the endpoints 110 and 180 are independently streaming a video from media host 106. It should be noted that the example of FIG. 1 shows only endpoints 110, 180, but the scope of embodiments is not limited to any particular number of endpoints. Rather, the techniques described herein may be scaled to mirror playback commands among any appropriate number of two or more endpoints.

Beginning at block 302, user A of endpoint 110 enters a playback command to a video player within client application 115 that is streaming video from media host 106. In some embodiments, a playback command includes pause, rewind, fast forward etc. Moving to block 304, the client application 115 sends the playback command to the media host 106, which then pauses, rewinds, fast forwards, etc. the video that is streaming to client application 115. As noted above, the playback command is implemented via an API. Therefore, when the user selects a playback command from the user interface, the media player translates that selection into a predefined set of control signals and causes the endpoint to send those control signals in a message (e.g., via HTTP over the Internet 120) to the media host server 106.

Moving to block 306, the client application 115, which monitors the commands given to the media player, detects the media playback control signal representing the playback command, compares the control signal to a pre-programmed set of control signals representing playback commands, recognizes the playback command and sends a data message to Web RTC server 130 over network 120 informing Web RTC server 130 that the playback command has been sent to media host 106. As noted above, the pre-programmed set of control signals representing playback commands corresponds to an API. The message from client application 115 to Web RTC server 130 may include a message having the API signals and/or other appropriate indication of the playback command.

Moving to block 308, the Web RTC server 130 then passes a message to client application 185 at endpoint 180 over network 120 informing client application 185 of the playback command. Similarly, the message from Web RTC server 130 to client 185 may include the API signals and/or another appropriate indication of the playback command. In some embodiments, the WebSocket protocol is used to send the message from Web RTC server 130 to endpoint 180 and vice versa. In other embodiments, any suitable transport protocol may be used to send the message from Web RTC server 130 to endpoint 180 and vice versa. In some embodiments, separate pieces of software or hardware on Web RTC server 130 may handle recognizing the playback command from client application 115 to media host 106 and sending the message to client application 185.

Moving to block 310, the client application 185 at endpoint 180 uses the information contained in the message from Web RTC server 130 to communicate signals according to the API to media host 106. Moving to block 312, the media host 106 responds to the signals by executing the playback command according to the API and pauses, rewinds, fast forwards, etc. the streaming video on the endpoints 102. In this way, the endpoints 110, 180 maintain synchronized video playback even when one of the endpoints chooses to pause, rewind, fast forward, or the like. It is understood that in other embodiments user B of endpoint 180 may enter the playback command in block 302, in which case endpoint 110 will be caused to mirror the playback command as described in blocks 304-310.

In some embodiments, the Web RTC server 130 may correct for latency between the media host 106 and the endpoints 110, 180 and between the Web RTC server 130 and the endpoints 110, 180 in order to delay executing a playback command for better synchronization. The information necessary to delay executing the playback command may be included in the message sent during block 308. In other embodiments, a separate message may be sent containing the information necessary to delay executing the playback command. In other embodiments, latency may be low enough that playback is acceptably close to perfect synchronization without correction for latency.

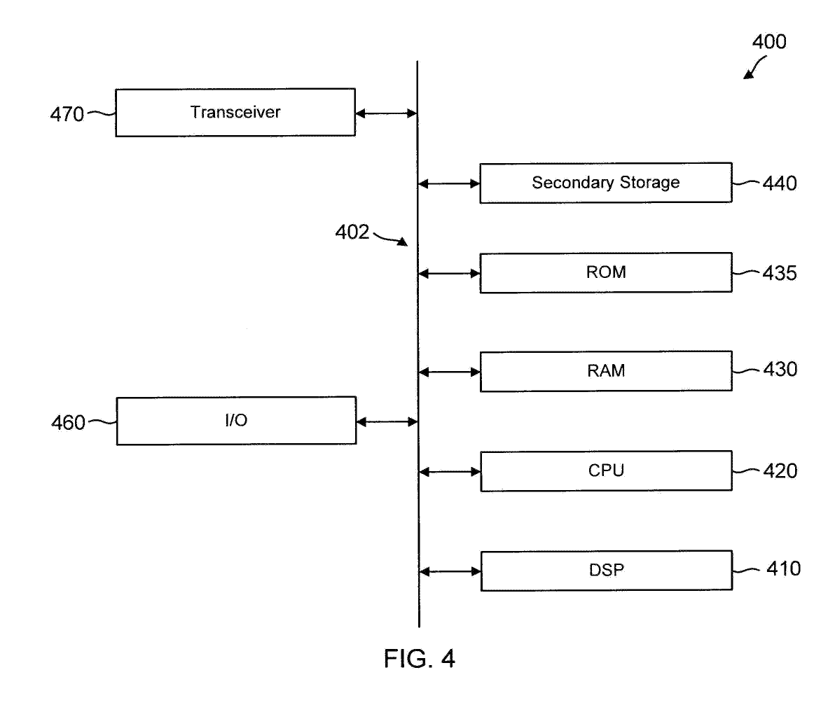

FIG. 4 illustrates an example computer system 400 adapted according to one embodiment of the present disclosure. The computer system 400 includes an example system on which embodiments of the present disclosure may be implemented (such as server 130, server 106, or user devices 110 and 180). The computer system 400 includes a digital signal processor (DSP) 410, a central processing unit (CPU), a random access memory (RAM) 430, a read-only memory (ROM) 435, secondary storage 440, input/output (I/O) devices 460, and a plurality of transceivers 470, all of which may be communicatively coupled via a bus 402.

The CPU 420 may be implemented using hardware or a combination of hardware and software. Although illustrated as a single CPU, the CPU 420 is not so limited and may comprise multiple processors. The CPU 420 may be implemented as one or more processors, i.e., as one or more chips, cores (e.g., a multi-core processor), field-programmable gate arrays (FPGAs), and/or application specific integrated circuits (ASICs). Likewise, the DSP 410 may be implemented as more than one DSP chip. The DSP 410 may perform transcoding or transrating of a media stream or call flow received by a transceiver 470.

The secondary storage 440 may comprise one or more disk drives or solid state drives and is used for non-volatile storage of data and as an over-flow data storage device if the RAM 430 is not large enough to hold all working data. The RAM 430 may be static RAM, dynamic RAM, or the like, and the ROM 435 may be programmable ROM (PROM), erasable PROM (EPROM), electrically EPROM (EEPROM), or the like. The secondary storage 440 may be used to store programs that are loaded into the RAM 430 when such programs are selected for execution. The ROM 435 is used to store instructions and perhaps data that are read during program execution. The ROM 435 is a non-volatile memory device that typically has a small memory capacity relative to the larger memory capacity of the secondary storage. The RAM 430 is used to store volatile data and perhaps to store instructions. Access to both the ROM 435 and the RAM 430 is typically faster than to the secondary storage 440.

The computer system 400 includes transceivers 470. There may be a transceiver 470 for each communication line (e.g., electrical or optical) coupled to the computer system 400. A transceiver 470 may be bidirectional or unidirectional, depending on the embodiment. Each transceiver 470 is adapted to couple computer system 400 to a communication link (e.g., a wired or wireless communication link). In the examples of FIG. 1, transceivers 470 may couple a respective device to network 120 and/or to another network (not shown) such as a cellular network or other telephony network.

The I/O devices 460 may include a keyboard, a computer mouse, a microphone, and/or a display device for allowing a user to provide input to and receive output from the computer system 400. In one example, the endpoint devices 110, 180 of FIG. 1 may include tablet computers having touchscreen interfaces, although the scope of embodiments is not limited to any particular I/O devices 460.

It is understood that by programming and/or loading executable instructions onto the computer system 400, at least one of the CPU 420, the RAM 430, and/or the secondary storage 440 are changed, transforming the computer system 400 in part into a particular machine or apparatus having the functionality taught by the present disclosure. The executable instructions may be stored on the RAM 430 or secondary storage 440 and loaded into the CPU 420 for execution. The device functionality described above with respect to FIGS. 1-3 and 5 may be implemented as a software application running on the CPU 420 and using the RAM 430, the ROM 435, and/or secondary storage 440.

Logic may be encoded in a non-transitory computer-readable medium, such as RAM 430 and/or secondary storage 440. Such a medium can take many forms, including but not limited to, non-volatile media and volatile media. In various implementations, non-volatile media includes optical or magnetic disks, such as secondary storage 440, and volatile media includes dynamic memory, such as various types of RAM 430. CPU 420 reads application code from the readable medium and executes the code to provide the described functionality.

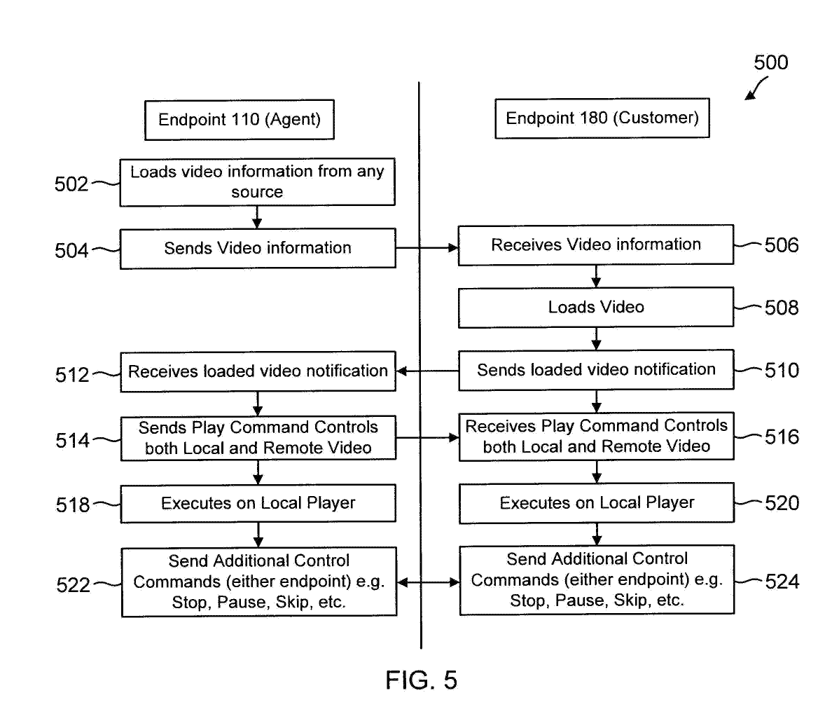

FIG. 5 is an illustration of a signal flow diagram 500 according to one embodiment of the present disclosure. In some aspects, the actions represented in diagram 500 correspond to blocks from methods 200 and 300 of FIGS. 2 and 3, respectively. The left side of diagram 500 illustrates actions taken at endpoint 110, which in this embodiment is used by a customer service representative, also referred to as a customer service agent. The right side of diagram 500 illustrates actions taken at endpoint 180, which in this embodiment is used by a customer.

Beginning at block 502, endpoint 110 loads streaming video information from any video source, for example a streaming video host. In some embodiments, streaming video information may include a URL or other identification pointing to a particular streaming video file. In other embodiments, any streaming media information may be loaded from any media source, for example a media host server 106. Accordingly, for the purposes of diagram 500, references to video are understood to include references to any media.

In some embodiments, the action of block 502 corresponds to a portion of block 202 of FIG. 2, and the action of block 502 may be performed by a client application 115 at endpoint 110. In those embodiments, loading streaming video information is implemented via an API. Therefore, when the customer service agent selects a video file, the client application 115 translates that selection into a predefined set of control signals and causes the endpoint 110 to send those control signals in a message to the media host server 106, as described at block 202.

Moving to block 504, endpoint 110 sends streaming video information. In some embodiments, the action of block 504 corresponds to a portion of block 202 of FIG. 2, and the streaming video information is sent to a media host server 106. In those embodiments, as shown in block 204 of FIG. 2, the client application 115 monitors for the streaming video information, compares the content of the streaming video information to a pre-programmed set of control signals representing playback commands, recognizes the command to play the selected media file and sends a data message to Web RTC server 130 over network 120. In other embodiments, the endpoint 110 at block 504 sends streaming video information directly to the Web RTC server 130 over network 120.

Moving to block 506, endpoint 180 receives streaming video information. In some embodiments, endpoint 180 receives the streaming video information from Web RTC server 130 over network 120 as shown in block 206 of FIG. 2. In other embodiments, endpoint 180 receives the streaming video information directly from endpoint 110 over network 120. Continuing with the example, a client application 185 running on endpoint 180 receives the streaming video information. The message from Web RTC server 130 to client 185 may include the API signals and/or another appropriate indication of the media playback selection and may include a URL or other identification pointing to a particular streaming video file.

Moving to block 508, endpoint 180 loads the selected streaming video according to the received streaming video information. In some embodiments, the action of block 506 corresponds to a portion of block 208 of FIG. 2. In those embodiments, the client application 185 at endpoint 180 accesses the streaming video file from the media host 106 by using the information contained in the message from Web RTC server 130 to communicate signals according to the API to media host 106.

In the embodiment of diagram 500, a type of latency correction occurs at blocks 510-516 to ensure that both endpoints 110, 180 begin playing the streaming media file in synchronization.

Moving to block 510, endpoint 180 sends a notification that it has loaded the streaming video indicated by the streaming video information. In some embodiments, the client application 185 causes endpoint 180 to send this notification. In some embodiments, this notification is sent to Web RTC server 130 via network 120. In other embodiments, this notification is sent directly to endpoint 110 via network 120.

Moving to block 512, endpoint 110 receives the notification that endpoint 180 has loaded the streaming video. In some embodiments, the client application 115 receives this notification from Web RTC server 130 via network 120. In other embodiments, this notification is received directly from endpoint 180 via network 120.

Moving to block 514, endpoint 110 sends a playback command, in this case “play,” to media host 106. In some embodiments, the action of block 514 corresponds to block 304 of FIG. 3. In those embodiments, client 115 on endpoint 110 may send the playback command to media host 106. As noted above, the playback command is implemented via an API. Therefore, the client application 115, or in some embodiments a media player within the client application 115, translates the playback command into a predefined set of control signals and causes the endpoint 110 to send those control signals in a message to the media host server 106, as described above at block 304.

Further in those embodiments of block 514, as shown in block 306 of FIG. 3, the client application 115 monitors the commands given to the media player, detects the media playback control signal representing the playback command, compares the control signal to a pre-programmed set of control signals representing playback commands, recognizes the playback command and sends a data message to Web RTC server 130 over network 120 informing Web RTC server 130 that the playback command has been sent to media host 106. As noted above, the pre-programmed set of control signals representing playback commands corresponds to an API. The message from the client application 115 to Web RTC server 130 may include a message having the API signals and/or other appropriate indication of the playback command. In other embodiments, the endpoint 110 at block 514 sends control signals representing playback commands directly to endpoint 180 over network 120.

Moving to block 516, the endpoint 180 receives the control signals representing the playback command, in this case “play.” In some embodiments, endpoint 180 receives the playback command from Web RTC server 130 over network 120 as shown in block 308 of FIG. 3. In other embodiments, endpoint 180 receives the control signals representing playback commands directly from endpoint 110 over network 120. In some embodiments, a client application 185 running on endpoint 180 receives the playback command. The message from Web RTC server 130 to client 185 may include the API signals and/or another appropriate indication of the playback command.

Moving on, blocks 518 and 520 occur simultaneously or near simultaneously so as to give the agent and the customer the perception of synchronization or near synchronization. At block 518, the playback command, in this case “play,” is executed on the media player of endpoint 110. In some embodiments, the media player is running on the client application 115. In those embodiments, the action of block 518 corresponds to a portion of block 202 of FIG. 2, specifically, the media host server 106 begins a stream including the requested media.

At block 520, the playback command, in this case “play,” is executed on the media player of endpoint 180. In some embodiments, the media player is running on the client application 185. In those embodiments, the action of block 520 corresponds to a portion of block 208 of FIG. 2, specifically, the client application 185 at endpoint 180 causes the media host 106 to begin streaming the selected media file to the client application 185. At this point, the media players of both endpoints 110, 180 are streaming the same media file from media host 106 in synchronization.

Moving to blocks 522 and 524, either endpoint 110,180 may initiate further playback commands, which are mirrored to the other endpoint 180, 110. In some embodiments, the actions of block 522 correspond to blocks 302, 304 of FIG. 3 and the actions of block 524 correspond to blocks 310, 312 of FIG. 3, or vice versa.

For example, at block 522 the customer service agent may enter a playback command to the media player on endpoint 110, as described above at block 302 of FIG. 3. Continuing at block 522 the endpoint 110 may issue the control signals corresponding to the playback command to the media host 106, as described above at block 304 of FIG. 3. As noted above, the playback command is implemented via an API. Therefore, when the user selects a playback command from the user interface, the media player translates that selection into a predefined set of control signals and causes the endpoint to send those control signals in a message to the media host server 106. As described with reference to block 514 above, which references block 306 of FIG. 3, the client application 115 informs the Web RTC server 130 that the playback command has been sent to media host server 106.

Moving to block 524, endpoint 180 receives the control signals corresponding to the playback command. This may be done by the client application 185, as described above with reference to block 516. The client application 185 at endpoint 180 then issues the playback command to media host 106 as described in block 310 of FIG. 3. Specifically, the client application 185 uses the information contained in the message from Web RTC server 130 to communicate signals according to the API to media host 106. Continuing at block 524 the endpoint 180 the media host 106 responds to the signals by executing the playback command according to the API and executes the playback command, which is reflected in the media player of endpoint 180, as described in block 312 of FIG. 3.

In the above discussions of blocks 522 and 524, commands could flow the opposite direction, from endpoint 180 to endpoint 110, in the same or similar manner. In this way the endpoints 110, 180 maintain synchronized video playback even when one of the endpoints chooses to pause, rewind, fast forward, or the like.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A computing device, the computing device being associated with a first user in a real time communication session over a network, the computing device comprising:
a memory containing machine readable medium comprising machine executable code having stored thereon instructions for performing a method of providing electronic media playback;
a processor coupled to the memory, the processor configured to execute the machine executable code to:
send and receive voice data with a second user at another computing device as part of the real time communication session;
during the real time communication session, detect media playback control signals sent by a media streaming application at the computing device; and
in response to detecting the media playback control signals, sending an indication of the media playback control signals to a session management server associated with the real time communication session.

2. The system of claim 1, wherein the media streaming application displays a video stream on the computing device.

3. The system of claim 1, wherein the media playback control signals represent media playback commands including at least one of: play, pause, fast forward, reverse, mute, and scrub.

4. The system of claim 1, wherein the media playback control signals represent a media playback command to begin streaming a media file.

5. The system of claim 1, wherein the computing device includes a personal computer, tablet computer; or a smart phone.

6. The system of claim 1, wherein the media streaming application runs within a client application that runs on the computing device.

7. The system of claim 1, wherein a client application that runs on the computing device performs the detecting the media playback control signals and the sending an indication of the media playback control signals to the session management server.

8. The system of claim 1, wherein the indication of the media playback control signals includes control signals corresponding to an application programming interface (API) associated with the media streaming application.

9. The system of claim 1, wherein the session management server includes a Web RTC server, and the real time communication session includes a Web RTC session.

10. The system of claim 1, wherein the processor is further configured to execute the machine executable code to:
receive an indication of media playback control signals from the session management server associated with the real time communication session; and
send the indicated media playback control signals to a media host via the media streaming application at the computing device.

11. A method performed by a session management server in a network, the session management server facilitating a real-time communication session between a first endpoint device and a second endpoint device, the method comprising:
monitoring the first endpoint device in the network for control signals sent from a media player on the first endpoint device to a media host corresponding to the media player;
recognizing at least one playback command by comparing the control signals to a predefined set of control signals; and
sending a message to the second endpoint device informing the second endpoint device of the at least one playback command.

12. The method of claim 11, wherein the control signals include an address for a streaming media file.

13. The method of claim 11, wherein the at least one playback command comprises at least one of: pause, play, fast forward, reverse, mute, and scrub.

14. The method of claim 11, wherein the session management server includes a Web RTC server, and the real-time communication session includes a Web RTC session.

15. The method of claim 11, wherein the message includes control signals corresponding to an application programming interface (API) associated with the media host and media player.

16. A computer program product having a computer readable medium tangibly recording computer program logic for synchronizing media playback at a first network device, the computer program product comprising:
code to engage in a real time communication session by sending and receiving at least voice data with a second network device;
code to monitor a media streaming player at the first network device for control signals communicated between the media streaming player and a media host server; and
code to send a message indicative of the control signals to a network session manager that is separate from the media host server.

17. The computer program of claim 16, further comprising:
code to compare the control signals against a set of predefined playback commands for the media host server; and
code to identify a first one of the playback commands from the set of predefined playback commands based on the comparing,
wherein the message indicative of the control signals is indicative of the first one of the playback commands.

18. The computer program product of claim 16, wherein the network session manager includes a Web RTC server, and wherein the real time communication session includes a Web RTC session.

19. The method of claim 16, wherein the playback commands include at least one of: pause, play, fast forward, reverse, mute, and scrub.

20. The method of claim 16, wherein the first network device and the second network device include at least one of a tablet computer, a laptop computer, and a smart phone.
